(19) United States
(12) Patent Application Publication
(10) Pub. No.: US 2007/0073578 A1
(43) Pub. Date: Mar. 29, 2007

(54) Dock management system and processing of product

(75) Inventor: J. Edward Roth, Lansdale, PA (US)

Correspondence Address: GREENBLUM & BERNSTEIN, P.L.C., 1950 ROLAND CLARKE PLACE, RESTON, VA, 20191, US

(73) Assignee: LOCKHEED MARTIN CORPORATION, Bethesda, MD (US)

(21) Appl. No.: 11/237,769

(22) Filed: Sep. 29, 2005

(51) Int. Cl. G06F 15/02; G07B 15/00; G06F 9/46; G07B 15/02; G06Q 10/00

(52) U.S. Cl. 705/13; 705/9; 705/28

(57) ABSTRACT

A system and method for dock management. The system includes a controller which stores and processes product information obtained from product. The product information includes at least product storage location and required process information. The controller activates a system which indicates the location of a particular product which is ready for removal from storage and processing in response to a facility requirement.

### FIELD OF THE INVENTION

The invention generally relates to a dock management system and method for processing products and, more particularly, to an intake management and processing system and methods thereof.

### BACKGROUND DESCRIPTION

The sorting of mail is a very complex, time-consuming task. In general, the sorting of mail is processed through many stages, including front-end processes such as, for example, processing of incoming mail pieces at a mail receiving dock area. The processing of mail pieces also includes back end process such as, for example, the unbundling and sorting and sequencing of mail pieces.

Most postal facilities within the United States have taken major steps toward automation by the implementation of a number of technologies. These technologies include, amongst others, letter sorters, parcel sorters, advanced tray conveyors, flat sorters and the like. As a result of these developments, postal facilities have become quite automated over the years, considerably reducing overhead costs and increasing mail throughput. However, certain processes are still manually performed such as, for example, the dock management process such as stacking and storage of mail for subsequent operations.

Current mail receiving docking systems do not have any centralized dock procedures which, in turn, leads to inefficient mail handing at the mail receiving dock and work space area, itself. This inefficiency ultimately affects the entire mail processing system, from transporting mail to the sorters/sequencers to the actual sorting and/or sequencing of such mail pieces.

By way of example, at the mail receiving dock, personnel unload pallets of mail (e.g., flats, letter mail, and other product (collectively referred to as product)) from trucks as they arrive from many different locations. As the pallets arrive, the product are processed which includes, for example, placing a tag on the pallet which is indicative of the day the product on the pallet must be processed. The pallets are then randomly placed on the work room floor, one level high, near parcel and bundle sorters. Due to the fact that the typically unevenly stacked pallets are randomly placed on the floor, it is not feasible to stack the pallets on each other to save valuable floor space since future processing would require the pallets to be unstacked. Thus, as can be imagined, the random placement of pallets, one level high, consumes a large amount of valuable storage space.

To process the pallets for each day, a manual search is made to locate the pallets which need to be processed for that day. As the pallets are located, they are transported to a holding or sorting area, where they may be unbundled, sorted, etc. However, searching for the pallets is very time consuming and inefficient, especially in view of the fact that the pallets are randomly placed over a large floor space.

By way of illustration, pallets which need to be processed for a certain day may be intermingled with other pallets, which requires movement of the pallets that are not being processed. If the pallets were stacked, for example, a higher level pallet would need to be removed in order to gain access to the lower level pallet. For this reason, and the nature of the unevenly loaded pallets, the pallets are not stacked on top of each other. But, the situation still exists that in order to transport the pallets to the unbundling or other storage area, other pallets have to be moved, thus requiring additional work, manpower and time. Also, in such a system, there is always the possibility of overlooking or missing pallets that need to be processed, thus delaying the delivery of such product.

Additionally, the pallets which need to be processed are unloaded to the bundle level. The bundles are then sorted and stored in bins on the floor until moved to the unbundling area for opening. After bundle opening, the product, e.g., mail, is again stored in carts on the floor until the carts are taken to the sorting machines for processing. This total process requires considerable handling, the most expensive storage space, and time.

The invention is directed to overcoming one or more of the problems as set forth above.

### SUMMARY OF THE INVENTION

In a first aspect of the invention, a dock management system includes a controller which stores and processes product information obtained from product. The product information includes at least product storage location and required process information. The controller activates a system which indicates the location of a particular product which is ready for removal from storage and processing in response to a facility requirement.

In a second aspect of the invention, a management system includes a multilevel storage rack system for storing product received from a receiving dock area. A system identifies a location of the product stored on the multilevel storage rack system and a controller obtains information associated with the product and uses the information to activate the system for identifying the location of the product and for directing the product to a processing location based on instructions of the controller.

In a third aspect of the invention, a system includes an adjustable multilevel storage rack system for storing mail pieces in containers or on pallets received from a receiving dock area. The system also includes a system for identifying a location of the mail pieces stored on the multilevel storage rack system. A controller obtains and stores product information associated with the stored mail pieces and models facility management. The controller uses the product information to activate the system for identifying the location of the stored mail pieces and to determine which preprocess and process is to be performed on the mail pieces. A handling mechanism, downstream from the adjustable multilevel storage rack system, preprocesses the mail process, prior to being directed to a processing location. A processing system processes the preprocessed mail pieces under direction of the controller into a sortation or sequence order.

In a fourth aspect of the invention, a method of managing product through a processing facility comprises transporting product stored in containers or pallets from a dock area to a multilevel storage area for storage at multiple heights. The method further includes retrieving and storing product information obtained from the pallets, containers or manifests associated with the product. A locating system is activated to locate the product for removal, upon a push or pull operation. The product is removed from the multilevel storage area and is inducted into a preprocessing or processing system, based on the product information.

### BRIEF DESCRIPTION OF THE DRAWINGS

FIG. 1 represents an overall schematic and flow of product of the management and related systems in accordance with the invention;

FIG. 2 shows a rack storage system in accordance with the invention;

FIG. 3 shows a bundle handling system in accordance with the invention; and

FIG. 4 shows steps implementing the invention.

### DETAILED DESCRIPTION OF EMBODIMENTS OF THE INVENTION

The invention is directed to a dock management system and method for processing product. The invention provides a semi-automated pallet and bundle handling solution for postal processing, warehousing and other types of storage and handling facilities. The invention provides the capability to efficiently move a far larger quantity of product, e.g., mail, from a receiving dock to processing machines or storage areas. The invention also reduces, considerably, the required floor space utilized in such facilities, as well as provides management of the mail or other product in storage so that it can be removed at the appropriate moment for “just in-time” preprocessing. The controlled storage and the “just in-time” removal systems of the invention also allow far greater numbers of incoming palletized mail or other product to be processed at a lower cost than with current processing methods.

The system of the invention further provides management information necessary for determining mail or other product quantity load and other information for more efficiently moving and processing the mail or other product. The system and method can also be implemented for warehousing applications and may be implemented, in one non-limiting illustration, as an intelligent dock storage system or as an intelligent dock storage system which includes an automated bundle distribution system to a next sort process.

### System of the Invention

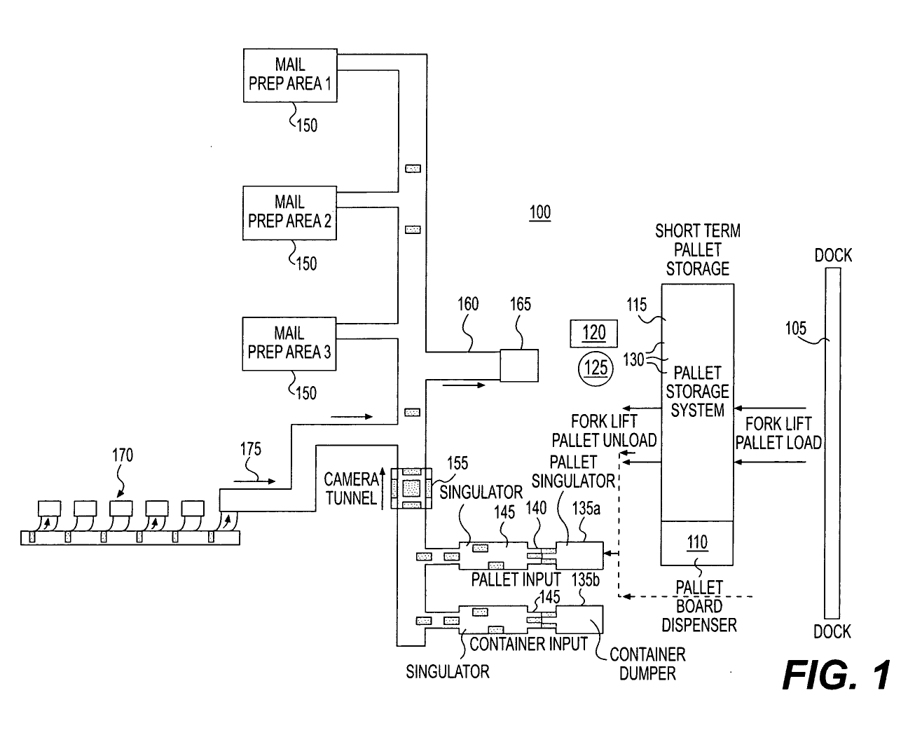

FIG. 1 represents an overall schematic and flow of product of the management and related systems in accordance with the invention. The overall related systems are generally depicted as reference numeral 100 and include, amongst other features, a loading dock 105 for unloading pallets or containers from arriving transports, e.g., trucks. Using a fork lift, for example, the pallets or containers are transported from the loading dock 105 to a pallet board dispenser 110, in one embodiment, and thereafter stored in a rack storage system 115.

The rack storage system 115, in embodiments, is a multi-level system which is capable of storing pallets at different levels, depending on the height of an individual pallet or container, via the use of the board dispenser 110. While access to the rack storage system 115 may be from one or both sides, and pallets or containers can be stored one or more deep and as high as physically feasible, best efficiency may be gained using a one-pallet(container)-deep rack, where pallets or containers are input on one side (typically dock side) and removed from the other side (typically plant floor side).

As the pallets or containers are placed in the rack storage system 115, information from a pallet “placard” or information card, placed on the pallets or containers, is obtained using a scanner, keyboard, or similar system, generally shown as reference numeral 120 The information may be in user readable format, or may be, for example, bar coded information or RF ID technology or the like. The obtained information may, include, for example, depth of sort of the bundles,
destination postal code(s),
date of requested delivery,
number of bundles, and
number of individual mail pieces or product, etc.

This electronic information will then be loaded into a controller 125 (intelligent pallet/bundle management system) which, in turn, will process such information to determine, for example, (i) what processes following storage must be completed on the mail pieces or other product (hereinafter referred to as product) prior to sortation, (ii) the specific sortation processors that need to be utilized for the process, (iii) the time that must be allotted for these processes and (iv) the exact location of the pallets or containers in storage based on, for example, reading a location bard code on a rack system at the position of load insertion. The controller 125 will also be linked to other subsystems for control and coordination of processes, as discussed in more detail below.

An alternate manner of gaining this information may include obtaining information electronically or directly from the product manifest provided by the mailer using, for example, the pallet placard as a pallet identification to allow data lookup from the manifest. This data or the previously discussed information, along with knowledge of when the sort of this particular product is scheduled (which is partially determined by mail quantity and pre-sort level), will then be used to determine exactly when the product is to be removed from storage.

Using light alarms, direction lights or simply a message via handheld display device, generally shown at reference numeral 130, the fork lift operator will locate and remove the correct pallet from the rack storage system 115 for future processing based on instructions from the management system. The light alarms, direction lights or handheld display device will be under control of the controller 125, and receive signals therefrom for identifying the location and/or processing requirements of the product. The pallet location may be stored in the controller by reading or obtaining information on the rack storage system 115 at the position of load insertion. This may be accomplished using bar code readers, rack sensors (e.g., photodiodes) or the like.

The pallet or container will be taken to a bundle handling system which may include, for example, a pallet unloader 135a and/or container dumper 135b. After induction and respective processing, the product will be inducted onto a conveyor 140 leading to a bundle singulator 145. The product can also be inducted directly to a bundle singulator 145 or other processing machine, without limitation to the invention.

Still referring to FIG. 1, the bundles of product can then be singulated into a single stream to be directed to a particular processing area/machine 150. In embodiments, using the information gained from the placard or manifest, the direction information can be determined using a number of methods. For example, a camera system 155 such as an optical reader, bar code reader, etc, can read the product information, e.g., addresses for direction information, or the pallet placard can again be scanned at the time of dump into the singulator 145 entrance.

By separating the product from each pallet or container, by timing the induction, the placard information can be used to determine the destination for the next process, avoiding the cost and inherent error rate of a camera address reading system. If the camera system 155 is present, individual reading errors can actually be resolved, since the stream of bundles from any particular pallet or container are typically going to the same destination.

In one illustrative example of destination area, once singulated into a stream, the bundles may be directed to a bundle opening process, directly to a flats or letter sorter or any other operation. In any scenario, by directing the single stream of bundles to the next operation, the next process can be accomplished more efficiently, without the need to wait for the next product.

In the case that product has been inducted into the system incorrectly, e.g., mislabeled pallets, wrong bundles on pallet, etc., or at a time when they cannot be processed, e.g., non-scheduled change in sort plans, sorting machine outage, etc., the product will be removed from the distribution system by the takeaway conveyor 160. Thus, any bundles not associated with the on-line sort plan will automatically be removed from processing.

One or more takeaway conveyors 160 may be setup to divert these product to either palletizers or to simply dump into containers at location 165. The palletized or containerized product may be taken back to the rack storage system 115, where the container (or pallet) can then be re-stored for short term storage. Additionally, as an option, the bundles can be sorted into a container, and thereafter stored for future processing. Based on the contents of the misdirected product, the container or pallet will again be withdrawn at the correct time to accomplish the necessary processing as discussed above.

It should be understood that bundles from pallets which must be processed on a bundle and parcel sorter before being transferred to flat mail processing can also be stored in the storage system. The pallets will be removed at the proper time, as directed by the controller, e.g., intelligent pallet/bundle management system (based on required processing time, destination, etc.), to be transported to the parcel and bundle sorter or other downstream operations. From the parcel and bundle sorter, the sorted bundles (typically sorted to a specific postal code), sorted into containers, can then be taken to the storage rack system. Extracting sort information from the parcel and bundle sorter, the container can be restored in the rack system, with the necessary information for later extraction. As an alternate, sorted bundles from the parcel and bundle sorter 170 could be moved directly to their next sort processing destination, via conveyor 175, with tracking to assure the particular product arrives at the correct destination.

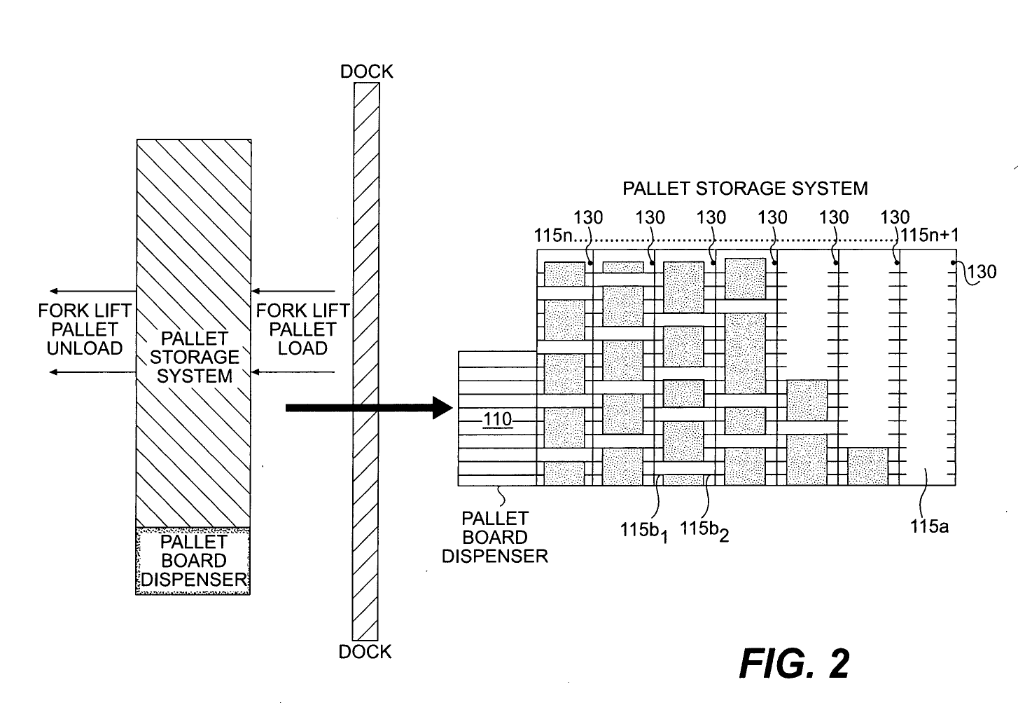

FIG. 2 shows the rack storage system 115 in accordance with the invention. The rack storage system 115 includes the pallet board dispenser 110, in addition to a rack system 115a. The pallet board dispenser 110 is a well known mechanism capable of dispensing pallet boards. For example, the pallet board dispenser 110 may include a jack-knife mechanism for lifting and a pushing system for separating individual pallet boards from a stack of pallet boards. This will allow an operator to place a pallet on a topmost pallet board, lift the pallet board and accompanying pallet or container and thereafter transport the assembly to the rack system 115a.

The rack system 115a includes a plurality of columns 115ₙ to 115ₙ₊₁, each including opposing projections 115b₁ and 115b₂ spaced at intervals throughout each of the columns 115n to 115ₙ₊₁. As discussed further below, the opposing projections 115b₁ and 115b₂ allows the system to have fully adjustable spacing for maximum storage density. In one implementation, the rack storage system 115 may be accessed from one or both sides, and pallets or containers can be stored one or more deep and as high as physically feasible. The storage of the pallets or containers in the rack storage system 115 saves valuable flooring space and allows for denser storage areas.

The rack storage system 115 also includes a signal and/or locator system 130, e.g., light or sound alarm, etc. for content tracking such as pallet location and removal based on, for example, processing requirements. In one embodiment, the system 130 can detect the exact location of the pallet or container, via a camera or bar code reader, record the exact location of the pallet and provide this information to the controller for future retrieval.

In an alternative embodiment, a light detection system may be utilized to record the location of the pallet or container. Using a pallet as an example, in such a system, the information associated with a pallet will be obtained, and the pallet will then be immediately stored within the rack storage system 115. As the pallet is being stored, a light beam for a particular location on the rack storage system 115 will be broken, for example, at which time a signal will be sent to the controller 125 indicating that a pallet has been stored at a particular location. The controller 125 will reconcile the location information with the identification of the pallet, and store such information for future retrieval of the pallet. In such situations, the controller 125, which stores and processes the information obtained from the placard or manifest, will use such information to direct future operation, e.g., direct the operator to take a certain pallet from the rack storage system and place it at a specific processing machine, depending on the specific application of use.

Still referring to FIG. 2, each column width is larger than the width of the pallet board (which is typically wider than the pallet or container); whereas, at least the leading edges of each of the opposing projections 115b₁ and 115b₂, in each of the columns 115ₙ to 115ₙ₊₁, are spaced apart at a distance which is less the width of the pallet board, pallet or container. In this configuration, the pallets or containers can be stored at varying heights in each of the columns 115ₙ to 115ₙ₊₁, independent of any of the spacing of other columns 115ₙ to 115ₙ₊₁. Making use of pallet boards to hold the pallets or containers allows for a much denser storage, as the pallets and/or containers can be placed as close as vertically possible, reducing “stored air”.

Thus, at this stage, it is contemplated that:
the pallet placard destination information is scanned or otherwise obtained in order to track the pallet into and out of the systems;
the pallet location is sensed and recorded;
based on active sort plans, the pallets to be processed are located and signaled for removal at the work floor side of the rack storage system; and
the pallet boards can be returned to pallet dispenser 110 after pallet processing.

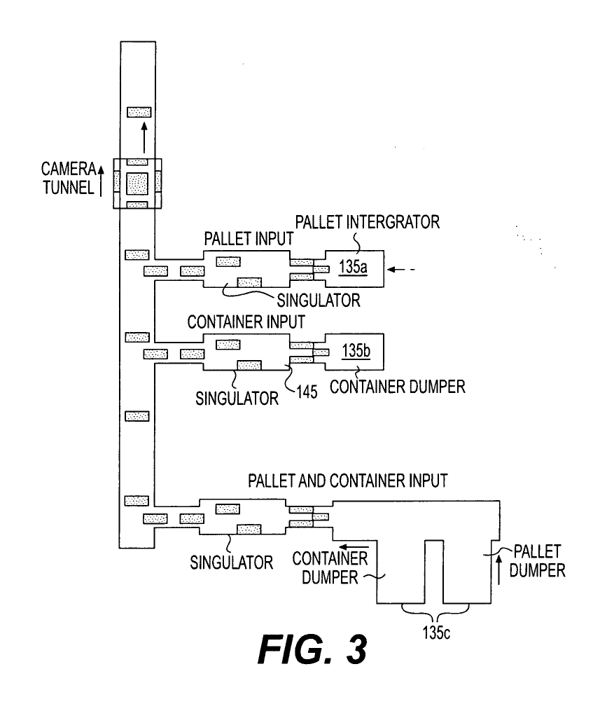

FIG. 3 shows the bundle handling mechanism of FIG. 1, with an alternative embodiment. In FIG. 3, the bundle handling mechanism is centralized, upstream of the feeders, sorters, etc. (not shown). In FIG. 3, the pallet unloader 135a and/or container dumper 135b are separate processing units, upstream from the singulator 145. The pallet unloader 135a, container dumper 135b and other components contemplated are known to those skilled in the art and may include, for example, units manufactured by Lockheed Martin Corporation.

The product can also be inducted directly to a pallet dumper and container dumper 135c or other processing machine, prior to being singulated. In the singulator 145, the product is singulated into a single row of product. The product is then transported to the camera system 155 such as an optical reader, bar code reader, etc, to read the product information. The product is then directed according to such product information, under control of the controller, to the appropriate processing machine.

The camera system 155 can be eliminated by using the tracking management system contemplated herein. By way of example, based on the information retrieved from the placard and/or manifest and under control of the controller 125, the system can track the bundles and/or product as it passes the singulator 145. This can be accomplished by sensors maintaining track of product entering the system. The sensors may include a photodiode which is activated upon a certain product breaking a light beam. As the light beam is broken, a signal will be sent to the controller, indicating that a certain product has passed through the photodiode. The controller will then reconcile this information with known information of the product as prior to or at the time it is initially inducted into the system. Knowing the position of the product through the system based such stored information will allow controller to direct the product to a certain processing unit.

### Method of Use

The intelligent pallet/bundle management control system of the invention is capable of determining when a pallet should be removed from the rack storage system so that it's contents can be processed. The pallet information (e.g., depth of sort of the bundles, destination postal code(s), date of requested delivery, number of bundles and number of individual mail pieces, etc.) obtained either from the pallet placard or from the pallet manifest can be input to the controller for facility system modeling (e.g., modeling of the planned activities and processing for a particular time period). The facility system modeling can also be modeled from historical product information.

The model can operate in one of two manners: pull or push. In the case of “pull” operation, the schedule, e.g., running of a specific sort plan, of systems (sorters, bundle preparation, etc) will be used to determine when a pallet is to be removed from storage. In the case of “push” operation, knowledge of specific contents of the storage system will be automatically input in real-time into the facility system modeler, e.g., controller, to determine when each of the required processes should be run to achieve maximum operational efficiency. This information may be used to schedule plant operations, personnel scheduling, etc., and will also determine when the pallets and/or containers are to be removed from storage.

In “push” operation, operations may be based on the current contents of storage, or can be based on scheduled pallet and/or container arrivals that may occur in real-time in conjunction with already stored contents. Obviously, operations must reach a level of reliable consistency before this latter operation, based on manifests received electronically before the actual contents have arrived, can be relied upon.

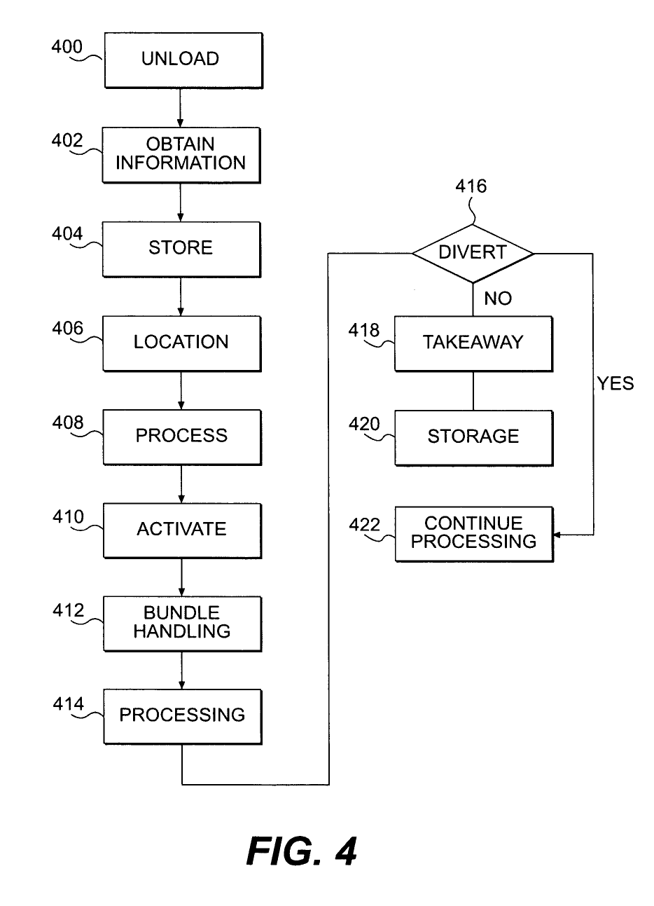

More specifically, FIG. 4 shows steps implementing the invention. The steps of the invention may be implemented by the controller on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. As an example, the steps implemented herein are illustrated using a pallet; however, it is contemplated that the system can be used with containers or the like.

At step 400, the product is unloaded onto a loading dock. At step 402, the product information is obtained and provided to the management system, e.g., controller, for processing. The information may include, for example, depth of sort of the bundles, destination postal code(s), date of requested delivery, number of bundles, and number of individual mail pieces or product, etc. The product are then transported from the loading dock to a pallet board dispenser and thereafter stored in a rack storage system, at step 404. The steps 402 and 404 may be interchangeable.

The obtained information may also be used to determine a precise position on the rack storage system for storage of the product. For example, the obtained height of the product can be used to determine the spacing needed for the adjustable rack system which, in turn, can be used to determine the most efficient use of the available space within the rack storage system. The information is then used to locate, on demand, for example, the exact location of product for future processing.

At step 406, the exact location of the product in the rack storage system is provided and stored in the controller. At step 408, using either a “pull” or “push” operation, the controller will process the relevant gathered information to determine, for example, (i) what processes following storage must be completed on the product prior to sortation, (ii) the specific sortation processors that need to be utilized for the process, or (iii) the time that must be allotted for these processes. The controller, at step 410, can activate the light alarms, direction lights or handheld display for the operator to locate and remove the correct pallet from the rack storage system for processing based on the management system.

At step 412, the product will be taken to a bundle handling system which may include, for example, a pallet unloader and/or container dumper or other upstream processing. After this induction and respective processing, the product will be inducted onto, a conveyor leading to a bundle singulator, at step 414. In embodiments, using the information gained from the placard or manifest, the direction information can be determined.

In one illustrative example of destination area, once singulated into a stream, the bundles may be directed to a bundle opening process, directly to a flats or letter sorter or any other pre-process. At step 416, a determination may be made as to whether the product should be processed, at this stage. If not, at step 418, one or more takeaway conveyors divert these product to either palletizers or to dump into containers. The palletized or containerized product may be taken back to the rack storage system at step 420. If the product is to be processed, at step 422, the product is transported to a downstream processing center, under control of the controller. In any scenario, by directing the bundles to the next process, the next process can be accomplished more efficiently, without the need to wait for the next product.

It should be understood that bundles from pallets which can be processed on a bundle and parcel sorter before being transferred to processing can also be stored in the storage system. The pallets will be removed at the proper time, as directed by the controller, e.g., intelligent pallet/bundle management system (based on required processing time, destination, etc.), to be transported to the parcel and bundle sorter. From the parcel and bundle sorter, the sorted bundles (typically sorted to a specific postal code), sorted into containers, can then be taken to the storage rack system. Extracting sort information from the parcel and bundle sorter, the container can be restored in the rack system, with the necessary information for later extraction. As an alternate, sorted bundles from the parcel and bundle sorter could be moved directly to their next sort processing destination, via conveyor, with tracking to assure the particular mail piece gets to the correct destination.

While the invention has been described in terms of preferred embodiments, those skilled in the art will recognize that the invention can be practiced with modification within the spirit and scope of the appended claims.

It is claimed:

1. A dock management system comprising a controller which stores and processes product information obtained from product and storage location, the product information includes at least product storage location and required process information, the controller activates a system which indicates the location of a particular product which is ready for removal from storage and processing in response to a facility requirement.

2. The system of claim 1, wherein the product information includes at least one of depth of sort of the bundles, destination postal code(s), date of requested delivery, number of bundles, and number of individual product.

3. The system of claim 1, wherein the facility requirement is provided by a facility system model which is modeled from at least historical product information and the product information.

4. The system of claim 3, wherein the facility system model models planned activities and processes for a particular time period.

5. The system of claim 3, wherein the model operates in a pull or push operation.

6. The system of claim 5, wherein,
in the pull operation, the model schedules system operations independent of the product information, and
in the push operation, the model schedules system operations based on at least one of specific contents of stored product obtained from the product information and scheduled arrival of the product that may occur in real-time in conjunction with already stored contents.

7. The system of claim 1, wherein the controller determines at least one of (i) what processes following storage are to be completed on the product prior to sortation, (ii) sortation processors that need to be utilized for the product, and (iii) a time allotted for the processes.

8. The system of claim 1, wherein the controller obtains the product information electronically from a product placard or a product manifest.

9. The system of claim 1, wherein the controller, based on the product information, determines when the product is to be removed from storage and future delivery for processing.

10. The system of claim 1, wherein the system includes light alarms, direction lights or a display device for locating the product.

11. The system of claim 1, wherein the product is mail pieces stored on pallets or in containers.

12. The system of claim 1, further comprising a multilevel adjustable storage rack system for storing the product.

13. The system of claim 12, wherein the multilevel adjustable storage rack system is at least one product deep and is accessible from two sides.

14. The system of claim 12, wherein the multilevel adjustable storage rack system includes a plurality of columns and a pallet board dispenser which stores pallet boards, the columns each including opposing aligned projections at intermittent spacing within the columns, each column width is larger than the width of the pallet boards and at least leading edges of each of the opposing aligned projections are spaced apart at a distance which is less the width of the pallet board.

15. The system of claim 1, further comprising a handling mechanism downstream from the adjustable storage rack system and upstream from a sorting machine.

16. The system of claim 1, further comprising a detection system, linked to the controller, which locates the product prior to being processed, and directs the product to a specific processing operation.

17. The system of claim 1, wherein the storage location of the product is obtained from an obtaining device which acquires such information at a position of loaded insertion of the product.

18. The system of claim 17, wherein the obtaining device is a bar code scanner or rack sensor.

19. A management system, comprising:
a multilevel storage rack system for storing product received from a receiving dock area;
a system for identifying a location of the product stored on the multilevel storage rack system; and
a controller which obtains information associated with the product and uses the information to activate the system for identifying the location of the product and for directing the product to a processing location.

20. The system of claim 19, wherein the product information includes at least one of depth of sort of the bundles, destination postal code(s), date of requested delivery, number of bundles, and number of individual product.

21. The system of claim 19, further comprising a facility system model which is modeled from at least historical product information and the product information, and uses such information to model planned activities and processing for a particular time period.

22. The system of claim 21, wherein the model operates in a pull or push operation, wherein
in the pull operation, the model schedules system operations independent of the product information, and
in the push operation, the model schedules system operations based on at least one of specific contents of stored product obtained from the product information and scheduled arrival of the product s that may occur in real-time in conjunction with already stored contents.

23. The system of claim 19, wherein the system includes light alarms, direction lights or a handheld display device.

24. The system of claim 19, wherein the product is mail pieces stored on pallets or in containers.

25. The system of claim 19, wherein the multilevel storage rack system includes:
multiple adjustable shelf systems to accommodate various heights of the product,
a plurality of columns for storage of the product; and
a pallet board dispenser which stores pallet boards, wherein:
the columns each including opposing aligned projections at intermittent spacing within the columns, each column width is larger than the width of the pallet boards or the product and at least leading edges of each of the opposing aligned projections are spaced apart at a distance which is less the width of the pallet board or the pallet.

26. The system of claim 19, further comprising a handling mechanism downstream from the storage pallet board and upstream from a sorting machine.

27. The system of claim 19, further comprising a detection system, linked to the controller, which locates the product prior to being processed, and directs the product to a specific processing operation.

28. The system of claim 19, wherein the storage location of the product is obtained from an obtaining device which acquires such information at a position of loaded insertion of the product.

29. The system of claim 28, wherein the obtaining device is a bar code scanner or rack sensor.

30. A system, comprising:
an adjustable multilevel storage rack system for storing mail pieces in containers or on pallets received from a receiving dock area;
a system for identifying a location of the mail pieces stored on the adjustable multilevel storage rack system;
a controller which obtains and stores product information associated with the stored mail pieces and models facility management, the controller using the product information to activate the system for identifying the location of the stored mail pieces and to determine which preprocess and process is to be performed on the mail pieces;
a handling mechanism downstream from the adjustable multilevel storage rack system which preprocess the mail pieces, prior to being directed to a processing location, based on the product information stored in the controller; and
an secondary operational system which processes the preprocessed mail pieces under direction of the controller into a sortation or sequence order.

31. The system of claim 30, wherein the adjustable multilevel storage rack system includes multiple adjustable shelf systems to accommodate various heights stacked mail pieces, the adjustable multilevel storage rack system includes a plurality of columns for storage of the product and a pallet board dispenser which stores pallet boards, the columns each including opposing aligned projections at intermittent spacing within the columns, each column width is larger than the width of pallet boards holding the mail pieces and at least leading edges of each of the opposing aligned projections are spaced apart at a distance which is less the width of the pallet boards.

32. A method of managing product through a facility, comprising:
transporting product stored in containers or pallets from a dock area to a multilevel storage system
retrieving and storing product information obtained from the pallets, containers or manifests associated with the product;
storing the product on the multilevel storage system at various heights;
activating a locating system to locate the product on the multilevel storage system for removal, based on a push or pull operation processed by a facility model; and
removing the located product from the multilevel storage system and inducting the product into a preprocessing or processing system, based on the product information.

33. The method of claim 32, wherein
in the pull operation, the model schedules system operations independent of the product information, and
in the push operation, the model schedules system operations based on at least one of specific contents of stored product and scheduled arrival of the product that may occur in real-time in conjunction with already stored contents.

34. The method of claim 33, further comprising diverting the product away from the processing system based on detected information of the product.

35. The method of claim 32, wherein the product comprises mail pieces.
